(19) United States
(12) Patent Application Publication
(10) Pub. No.: US 2003/0172493 A1
(43) Pub. Date: Sep. 18, 2003

(54) Hinge mechanism for folding table legs

(75) Inventors: Poul Christiansen, Frederiksberg (DK); Claus Molgaard, Copenhagen NV (DK)

Correspondence Address: KLEIN, O'NELL & SINGH, Ste. 510, 2 Park Plaza, Irvine, CA, 92614, US

(73) Assignee: HOWE Europe A/S, Middelfart (DK)

(21) Appl. No.: 10/367,636

(22) Filed: Feb. 14, 2003

Related U.S. Application Data
(60) Provisional application No. 60/361,052, filed on Feb. 28, 2002.

(30) Foreign Application Priority Data
Feb. 18, 2002 (DK) PA 2002 00252

(51) Int. Cl. E05D 15/50

(52) U.S. Cl. 16/232

(57) ABSTRACT

A hinge mechanism for folding a table leg against a table top includes a body that is attachable to the table top and that has a cavity formed therein, and a pivot having a first portion and a second portion, the first portion being connectable to the table leg, the second portion being generally cylindrical and axially displaceable and rotatable between a first rotational position and a second rotational position in the cavity. The second portion of the pivot has a radially protruding first projection and a biasing element that applies a biasing force to urge the pivot in a first direction parallel to the axis of the second portion. Preferably, the cavity includes first and second recesses that receive the first projection when the second portion is displaced in the first direction in the first and second rotational positions, respectively.

### CROSS-REFERENCE TO RELATED APPLICATION

This application claims the benefit, under 35 U.S.C. §119(e), of co-pending provisional application No. 60/361,052, filed Feb. 28, 2002, the disclosure of which is incorporated herein by reference.

### FEDERALLY SPONSORED RESEARCH OR DEVELOPMENT

Not Applicable

### BACKGROUND OF THE INVENTION

The present invention relates to a hinge mechanism for folding table legs of the type having locking means for releasably locking the legs of a table at least in the unfolded condition of the table, wherein the table is ready for use.

In many situations it is desirable to be able to fold the legs of a table such that the legs abut the table top so as to save space and to allow easy storage and transport of the table.

Such a folding table is disclosed in UK patent application GB 2 049 025 where a hinge mechanism comprises an open U-shaped bracket attached to the bottom surface of a table top, and is provided with a shaft around which a leg of the table may pivot from a folded to an unfolded position, locking means being provided for locking the leg in both positions, the leg being released from both locked positions by manually displacing the leg along the shaft against the force of a coil compression spring. The mechanism is open and therefore can cause severe pinching of fingers during the locking and pivoting operations. Furthermore, the unfolding of the legs requires release of the locking mechanism which is rather impractical when setting up the table. Finally, the hinge mechanism is rather large and unsightly.

### SUMMARY OF THE INVENTION

One of the objects of the present invention is to provide a hinge mechanism of the type disclosed in the above-cited reference that avoids the risk of pinching fingers, wherein the unfolding operation is more practical, and that has a compact and attractive design.

According to the invention this object is achieved by the mechanism comprising a pivot having a first and a second portion, the first portion being adapted for integral or releasable connection to a leg of a table, the second portion being generally cylindrical and axially displaceable and rotatable between a first rotational position and a second rotational position in a cavity or hollow of a body adapted for being attached to a table top, said second portion comprising a radially protruding first projection, a biasing means being provided for urging said pivot in a first direction parallel to the axis of said second portion, said cavity or hollow comprising a first and a second recess adapted for receiving said first projection when said second portion is displaced in said first direction in said first and second rotational positions, respectively.

All the cooperating locking and rotating means are enclosed in a cavity or hollow, such that little or no pinching of fingers is possible. Furthermore, the design is compact and practical to operate.

In the currently preferred embodiment of the hinge mechanism according to the invention, the shape of said first projection is such relative to the shape of said first recess that rotation of said second portion is not allowed when said first projection is received in said first recess, and said shape of said first projection is such relative to the shape of said second recess that rotation of said second portion from said second position towards said first position causes said pivot to move in a second direction opposite said first direction against the biasing force of said biasing means.

The unfolding of the leg may be carried out simply by applying a certain force to the leg in the unfolding direction without having to perform any extra unlocking operation.

In the currently preferred embodiment, said second recess comprises a sloped surface arranged at an angle relative to said first direction, said first projection having a surface portion adapted to glide along said sloped surface when said second portion is displaced in said first direction in said second rotational position, and said first projection is shaped like a wedge tapering in said first direction to a front edge of said wedge. Thus, a self-centering effect is achieved between the wedge and the first recess

In said currently preferred embodiment, said surface portion is constituted by said front edge, and said biasing means comprises a coil compression spring, said cavity or hollow being provided with a first abutment means and said second portion being provided with a second projection, said coil spring being arranged such that one end thereof abuts said abutment means, and the other end thereof abuts said second projection.

Preferably, said second projection is constituted by at least a portion of an annular circumferential collar.

So as to achieve a more stable and secure locking function in the unfolded position of the leg, said second portion may comprise a third radially protruding projection, said cavity or hollow comprising a third recess adapted for receiving said third projection in said first rotational position of said second portion.

In the currently preferred embodiment, said sloped surface is a surface of a rib or wall provided in said cavity or hollow, and is made of a resilient plastic material such as polyarylamide with 50% glass fibers admixed. Thus, a particularly efficient and durable frictional braking retention of the leg in the folded position is achieved.

Preferably, a first stop surface is provided in said cavity or hollow for cooperation with a second stop surface of said second portion for determining said second rotational position.

So as to be able to vary the retention force in the folded position of the leg, the position of said first and/or second stop surface may be adjustable for adjusting the location of said second rotational position, and said first stop surface may comprise the end of a screw or bolt.

So as to able to adjust the retention force from the outside of the body, said screw or bolt may extend from the outer surface of said body, such that said screw or bolt may be rotated from outside said body.

The present invention further relates to a hinge mechanism for folding table legs, the mechanism comprising a pivot adapted for integral or releasable attachment to a leg of a table and for pivotable attachment to a table top such that the pivot can rotate between a first position corresponding to the unfolded position of said leg and a second position corresponding to the folded position of said leg, releasable locking means being provided for releasable locking of said pivot in said first position, and frictional brake means being provided for frictionally retaining said pivot in said second position and to a folding leg table comprising a hinge mechanism as disclosed above.

### BRIEF DESCRIPTION OF THE DRAWINGS

In the following, the invention will be explained more in detail with reference to a currently preferred embodiment shown, solely by way of example, in the accompanying drawings where:

FIGS. 1 and 2 are schematic bottom perspective views of a folding table with legs unfolded and folded, respectively,

FIG. 3 is a schematic exploded perspective view of a currently preferred hinge mechanism according to the invention seen in the direction towards the bottom of the associated table top,

FIG. 4 is a schematic exploded perspective view of the mechanism of FIG. 2 seen in the direction opposite to the view direction in FIG. 3,

FIGS. 5-8 are a series of schematic bottom plan views of the hinge mechanism showing different stages in the folding operation of the hinge mechanism and the associated table leg or legs,

FIG. 9 is a schematic perspective view of the top bracket portion shown in FIG. 4 with the encircled region A cut away,

FIG. 10 is a bottom plan view of the top bracket portion of FIGS. 4 and 9,

FIG. 11 is a sectional view taken along line A-A in FIG. 10,

FIG. 12 is an enlarged scale view of the encircled region B in FIG. 11, and

FIG. 13 is an enlarged scale view, similar to FIG. 12, of an alternative embodiment with an adjustable holding resistance in the folded position of the table.

### DETAILED DESCRIPTION OF THE INVENTION

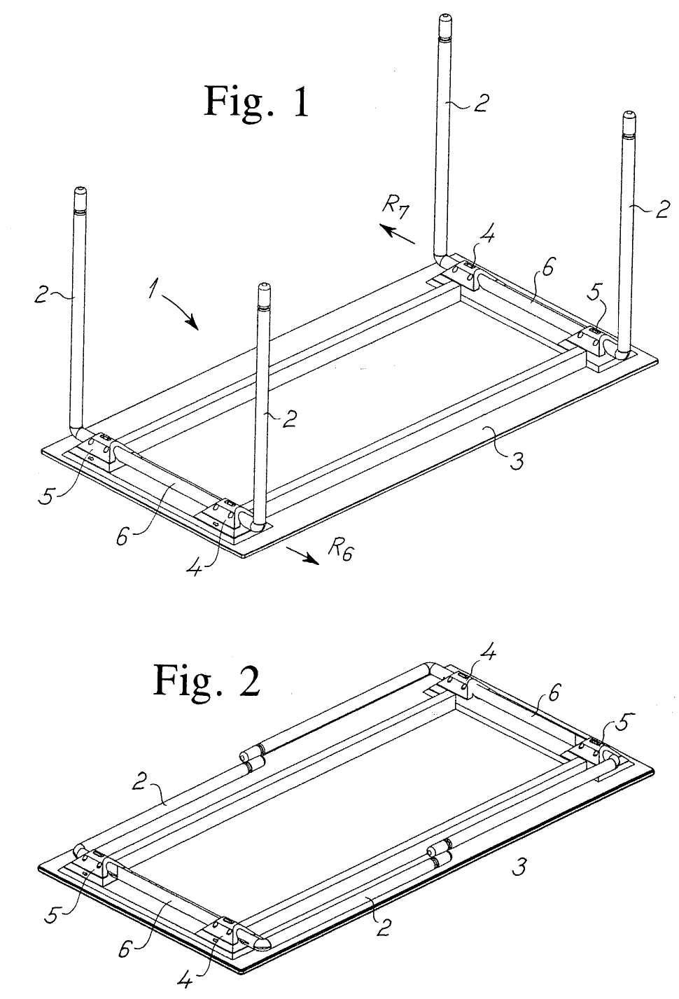

Referring first to FIGS. 1-2, a table 1 is shown having four folding legs 2 pivotably attached to the bottom surface of a table top 3 by means of hinge mechanisms 4 and 5, according to the invention, attached to the bottom surface. The legs 2 are paired by means of connecting rods 6, such that folding of the legs 2 from the unfolded position in FIG. 1 to the folded position in FIG. 2 takes place pairwise. The hinge mechanism according to the invention may just as well be utilized in connection with legs that fold singly, i.e., not in pairs. In that case, the connecting rods 6 are left out.

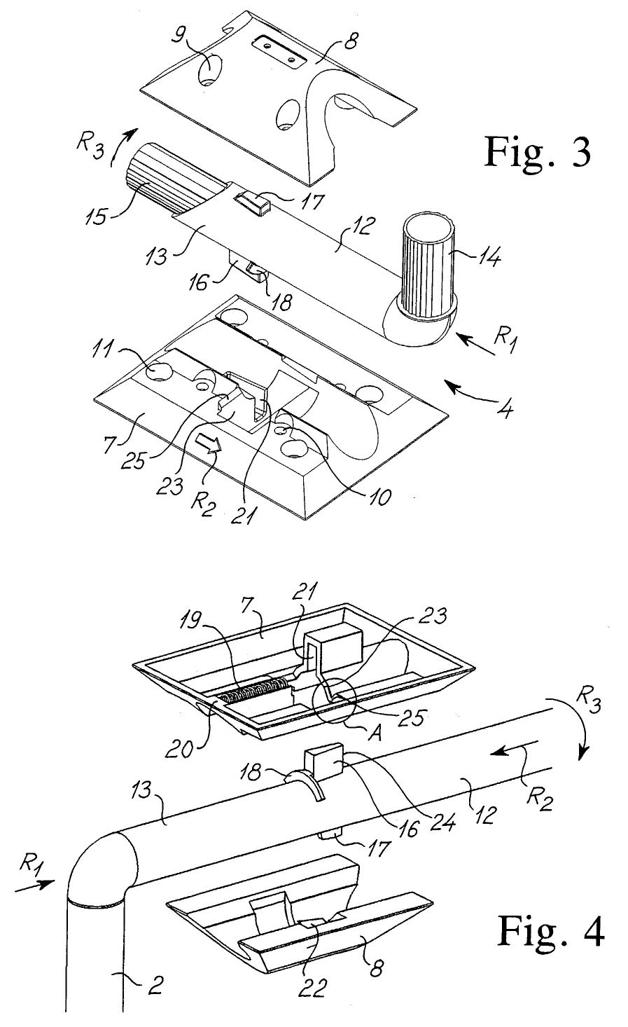

Referring now to FIGS. 3 and 4, the hinge mechanism 4 comprises top and bottom bracket portions 7 and 8, respectively, intended for being attached to one another by attachment means such as screws (not shown) extending through four holes 9 and 10 in the portions 8 and 7, respectively. The top portion 7 is intended to be attached to the bottom of the table top 3 by attachment means such as screws (not shown) extending through four holes 11. In FIG. 4 many of the details shown in FIG. 3 are left out for the sake of clarity.

When the top and bottom portions 7 and 8 are attached to one another, they define an interior hollow for receiving a cylindrical portion 12 of a pivot 13 having an end portion 14 for insertion in an aperture in the top of a leg 4 for connecting the leg to the pivot 13. The pivot has a second end portion 15 for insertion in an aperture in a connecting rod 6 for connecting the pivot 13 to the connecting rod. The end portions 14 and 15 have longitudinal surface grooves for frictionally engaging the leg 2 and the rod 6, respectively.

The cylindrical portion 12 has a radial wedge shaped locking projection 16 and a diametrically opposed radial wedge shaped locking projection 17. The cylindrical portion 12 is furthermore provided with an annular collar or circumferential projection 18 (best seen in FIG. 4) intended to serve as an abutment for one end of a compression spiral spring 19, the other end abutting against a shoulder 20 provided in bracket portion 7.

The bracket portions 7 and 8 are provided with wedge shaped locking recesses 21 and 22 for receiving the locking projections 16 and 17, respectively when the coil compression spring 19 urges the pivot 13 in the direction of arrow R1 while the pivot is in the rotational position shown in FIGS. 3 and 4 corresponding to the unfolded position of the legs 2 shown in FIG. 1, i.e. with the end portion 14 substantially at right angles to the bottom surface of table top 3.

The top bracket portion 7 is provided with a flat gliding surface 23 arranged mechanisms 4 and 5, according to the invention, attached to the bottom surface. The legs 2 are paired by means of connecting rods 6, such that folding of the legs 2 from the unfolded position in FIG. 1 to the folded position in FIG. 2 takes place pairwise. The hinge mechanism according to the invention may just as well be utilized in connection with legs that fold singly, i.e., not in pairs. In that case, the connecting rods 6 are left out.

Referring now to FIGS. 3 and 4, the hinge mechanism 4 comprises top and bottom bracket portions 7 and 8, respectively, intended for being attached to one another by attachment means such as screws (not shown) extending through four holes 9 and 10 in the portions 8 and 7, respectively. The top portion 7 is intended to be attached to the bottom of the table top 3 by attachment means such as screws (not shown) extending through four holes 11. In FIG. 4 many of the details shown in FIG. 3 are left out for the sake of clarity.

When the top and bottom portions 7 and 8 are attached to one another, they define an interior hollow for receiving a cylindrical portion 12 of a pivot 13 having an end portion 14 for insertion in an aperture in the top of a leg 4 for connecting the leg to the pivot 13. The pivot has a second end portion 15 for insertion in an aperture in a connecting rod 6 for connecting the pivot 13 to the connecting rod. The end portions 14 and 15 have longitudinal surface grooves for frictionally engaging the leg 2 and the rod 6, respectively.

The cylindrical portion 12 has a radial wedge shaped locking projection 16 and a diametrically opposed radial wedge shaped locking projection 17. The cylindrical portion 12 is furthermore provided with an annular collar or circumferential projection 18 (best seen in FIG. 4) intended to serve as an abutment for one end of a compression spiral spring 19, the other end abutting against a shoulder 20 provided in bracket portion 7.

The bracket portions 7 and 8 are provided with wedge shaped locking recesses 21 and 22 for receiving the locking projections 16 and 17, respectively when the coil compression spring 19 urges the pivot 13 in the direction of arrow R1 while the pivot is in the rotational position shown in FIGS. 3 and 4 corresponding to the unfolded position of the legs 2 shown in FIG. 1, i.e. with the end portion 14 substantially at right angles to the bottom surface of table top 3.

The top bracket portion 7 is provided with a flat gliding surface 23 arranged perpendicular to the axis of the portion 12 and along which the front edge 24 of the wedge shaped projection 16 glides when the pivot 12 is rotated in the direction of the arrow R3 subject to the biasing force of the spring 19 in the direction R1.

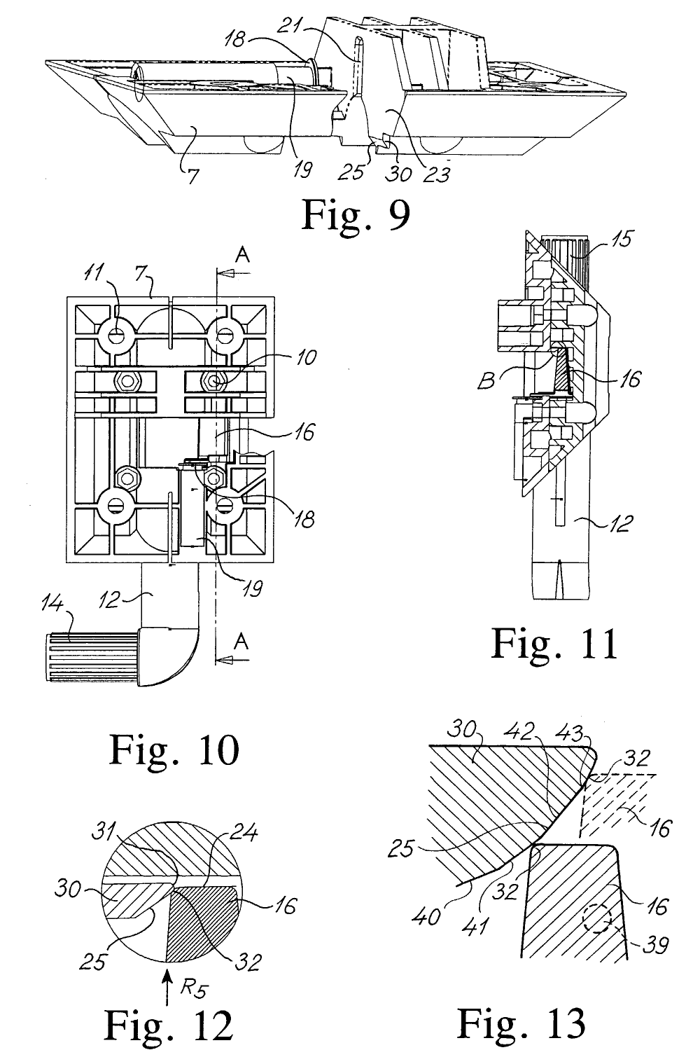

Adjacent the flat gliding surface 23, a sloped gliding and braking surface 25 is provided such that a shallow recess is formed into which the edge 24 of the wedge 16 glides along said sloped surface 25 urged by the coil spring 19 (in the direction R1) when the pivot 13 has been rotated approximately 90 degrees in the direction of arrow R3 from the position shown in FIGS. 3 and 4. The sloped gliding and braking surface is shown from other angles and in larger scale in FIGS. 9, 11 and 12

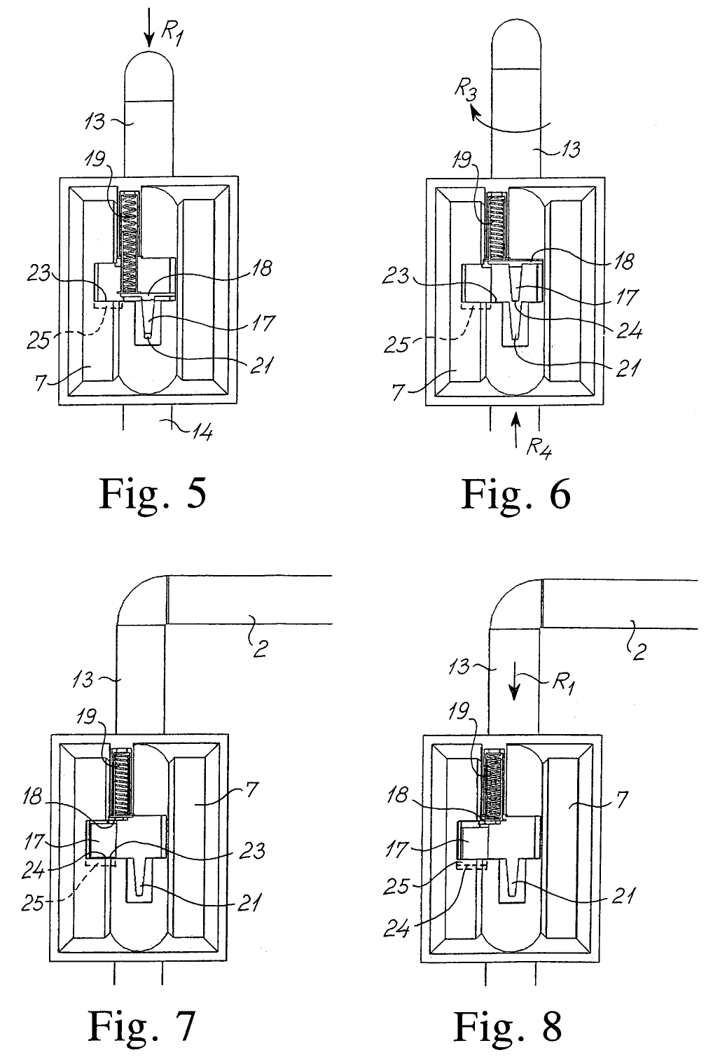

Referring now to FIGS. 5-8, different stages in the process of folding a leg from the locked position thereof shown in FIG. 1 to the folded position shown in FIG. 2 are illustrated.

In FIG. 5 the wedge projections 16 and 17 are inserted fully in the respective wedge shaped recesses 21 and 22 and held there by the coil spring 19 such that an effective locking of the leg 2 in the unfolded position of FIG. 1 is achieved. The coil spring is in its most extended position.

In FIG. 6, the pivot 13 with leg 2 and connecting rod 6 has been pulled manually in the direction R4 against the force of the coil spring 19 which is in its most compressed position. Hereby, the wedges 16 and 17 are fully extracted from the respective recesses 21 and 22 and the pivot 13 is free to be rotated in the direction R3 (counter-clockwise when viewed in the direction R4) with the front edge 24 of the wedge 17 gliding along the flat surface 23.

In FIG. 7 the pivot 13 has been rotated approximately 90 degrees, and the front edge 24 is located at the boundary between the flat glide surface 23 and the sloped glide and brake surface 25 shown in dotted lines because it is located lower than the flat surface 23.

In FIG. 8, the pivot 13 has been rotated slightly further in the direction R3 and the front edge 24 has glided down the sloped surface 25 in the direction R4 under the influence of the force of the spring 19 and is in the position shown in FIG. 12. This is the holding position where the legs 2 are held in the folded position by the resistance against rotation of the pivot 13 in the unfolding direction resulting from the force of the spring 19 that must be overcome, and the friction between the sloped surface 25 and the front edge 24 of the wedge 16.

This resistance is not a locking action but a holding action that results in that the leg 2 may be unfolded by merely pulling the leg against the resistance. Hereby, the legs 2 are maintained in the folded position of FIG. 2 by the resistance against rotation that relatively easily may be overcome, and does not require any other manipulation than more or less gently pulling on the legs 2. This facilitates the use of the folding table, as the legs are maintained in the folded position during transport and storage, but it allows rapid and easy unfolding of the legs.

In FIG. 9, a portion of the lateral wall of the bracket portion 7 has been cut away to show how the sloping surface 25 is achieved by means of an elongate rib or wall 30 with a tapered cross section.

FIGS. 10-12 further illustrate the design of the sloping surface 25 on the tapered rib 30. In FIG. 12 it can be seen how the rounded top 31 of the rib 30 cooperates with the rounded corner edge 32 of the front edge 24 of the wedge 16 in the holding position. The rib 30 is made of a relative hard but somewhat resilient plastic material (polyarylamide with 50% glass fibers admixed, such as the product sold under the trade name of IXEF 1022), while the wedge 16 is made of die-cast zinc. When the leg 2 is to be unfolded, the top 31 and the corner edge 32 will disengage with a click caused by a relief of a deformation of the rounded top 31 by the corner edge 32. Moreover, as the surface 25 is slightly rough, a certain friction between the corner edge 32 and the surface 25 will, together with the force of the spring 19 in the direction R5, exert a certain further resistance against rotation of the pivot 13 in the leg-unfolding direction.

The resistance against unfolding may be varied by varying the inclination and width of the surface 25 as well as the surface texture and thereby the friction between the surface 25 and corner edge 32. The further the rounded corner edge 32 of the wedge 16 is located past the start of the curvature of the rounded top 31 in the holding position, the greater the initial deformation when unfolding, and thereby the resistance against unfolding (the aforementioned “click”), will be. If the rounded corner edge 32 is too far beyond the curvature start, the wedge will be locked behind the rib 30. Therefore, such a situation should be prevented, either by limiting the rotation of the pivot in the folding direction of the pivot, and/or by limiting the inward travel of the wedge 17 past the rounded top edge 31. In the currently preferred embodiment, the rotation is stopped by an abutment on the bracket portion 8 against which the wedge 17 abuts in the holding position shown in FIG. 12.

As all the locking and holding elements are enclosed in the hollow or cavity formed between the two bracket portions 7 and 8, there is little or no risk that fingers will be pinched during folding and unfolding of the legs.

When the legs 2 are connected in pairs by the connecting rods 6 as shown in FIGS. 1-2, the brackets of each pair are inverted relative to one another such that the end portions 14 and 15 of the hinge mechanism 5 are oriented relative to the compression direction of the spring 19 thereof opposite the orientation thereof in the hinge mechanism 4, such that both hinge mechanisms 4 and 5 of a pair of legs 2 may be unlocked by exerting a force on one of the legs of each pair in the direction R6 or R7, respectively.

If the hinge mechanisms 4 and 5 of each leg pair are arranged as shown in FIG. 1 such that all the legs 2 are equidistant from the respective corners of the table top 3 so that no unsightly asymmetry arises, then the distance of travel between the fully extended condition of the spring 19 (FIG. 5) and the fully compressed condition thereof (FIG. 6) should be at least equal to half the thickness of the legs 2, such that the legs of each pair will be staggered enough in the folded position that all the legs may be folded up to abut the table top 3 as shown in FIG. 2, thereby allowing stable stacking of the folded tables on top of each other.

The design of the locking projections 16 and 17 as wedges, and the corresponding recesses 21 and 22 as wedge-shaped spaces, afford the advantage of the insertion of the wedges in the recesses being self-centering. This self-centering therefore compensates for inaccuracies in the alignment, synchronization, or matching of the two cooperating hinge mechanisms 4 and 5 for a pair of legs 2. Furthermore, any wear of a recess in the plastic material of the bracket portions 7 and 8 will be compensated by the wedge shapes, and therefore such wear will not result in any play in the locking function of the wedge/recess locking mechanism. Thus the table will be stable in the unfolded condition even after considerable wear of the recesses 21 and 22. Although two wedges 16 and 17 are utilized for the sake of strength, one wedge 16 is only necessary to achieve most of the advantages of the present invention. The locking projection 16 may have other shapes such as a cylinder, a cone or a truncated cone, the recess 21 having a suitable shape for retaining the projection in a locked relationship with compensation for wear.

Other frictional braking designs for holding the pivot 13 in the folded position with a force that can be overcome by a relatively weak unfolding pull on the legs 2 are conceivable. A projection on the pivot may for instance be inserted between two resilient rough surfaces or into an aperture in a rubber body such that a frictional resistance to retract the projection from between the two surfaces or from the aperture is achieved, resulting in the desired relatively weak holding resistance against unfolding of the legs 2.

The sloped surface 25 may be wider and have different angles of slope or a continually increasing angle—for instance a curved surface such that the holding force is increased the further the rounded corner edge 32 travels up the surface 25 until being stopped by the abutment mentioned above.

The abutment on the bracket portion 8 mentioned above for stopping the rotation of the pivot 13, and thereby limiting the travel distance of the wedge along the surface 25 in the direction of the force of the spring 19, may be substituted by a screw or bolt 39 (FIG. 13) that is accessible from outside the bracket 8 so as to be adjustable, so that the degree of rotation of the pivot 13, and thereby the travel distance, may be varied, thus allowing the intensity of the leg-holding resistance or brake to be varied by the end user of the table according to the desired degree of retention of the legs in the folded position thereof. Such adjustability of the travel distance/rotation may be combined with an increasing degree of slope of the surface 25, as indicated in FIG. 13, wherein it is illustrated that the further the rounded corner edge 32 travels in the direction R5, the steeper is the slope of the contacted portion of the sloped surface 25, the sloped surface being composed of three flat zones 40, 41 and 42, each with a different angle of slope, and a rounded zone 43 with a continuously increasing angle of slope.

For a given coil spring 19, the resistance against rotating the pivot 13 in the direction from the folded position of the legs to the unfolded position thereof is substantially larger for an initial position of the wedge 16 as shown with dotted lines in FIG. 13 than for an initial position thereof as shown with full lines. Thus if the allowed degree of rotation of the pivot is increased, for instance by adjusting the abutment or stop screw or bolt 39 mentioned above to protrude more or less into the hollow of the bracket, then the holding force in the folded position of the legs will be smaller or larger, respectively.

Although a preferred embodiment is disclosed herein, it will be appreciated that a number of variations and modifications will suggest themselves to those skilled in the pertinent arts. Such variations and modifications should be considered within the spirit and scope of the claims that follow.

What is claimed is:

1. A hinge mechanism for folding a table leg toward a table top of a table, the mechanism comprising:
a body that is attachable to the table top and having a cavity formed therein; and
a pivot having a first portion and a second portion, the first portion being connectable to the table leg, the second portion being generally cylindrical and axially displaceable and rotatable between a first rotational position and a second rotational position in the cavity, said second portion comprising:
a radially protruding first projection; and
a biasing element adapted for applying a biasing force to urge said pivot in a first direction parallel to the axis of said second portion, said cavity comprising first and second recesses adapted for receiving said first projection when said second portion is displaced in said first direction in said first and second rotational positions, respectively.

2. The hinge mechanism according to claim 1, wherein the shape of said first projection is such relative to the shape of said first recess that rotation of said second portion is not allowed when said first projection is received in said first recess, and said shape of said first projection is such relative to the shape of said second recess that rotation of said second portion from said second position towards said first position causes said pivot to move in a second direction opposite said first direction against the biasing force of said biasing element.

3. The hinge mechanism according to claim 2, wherein said second recess comprises a sloped surface arranged at an angle relative to said first direction, said first projection having a surface portion positioned to glide along said sloped surface when said second portion is displaced in said first direction in said second rotational position.

4. The hinge mechanism according to claim 3, wherein said first projection is shaped like a wedge tapering in said first direction to a front edge of said wedge.

5. The hinge mechanism according to claim 3, wherein said surface portion is constituted by said front edge.

6. The hinge mechanism according to claim 1, wherein said biasing element comprises a coil compression spring, said cavity being provided with a first abutment means and said second portion being provided with a second projection, said coil spring being arranged such that one end thereof abuts said abutment means and the other end thereof abuts said second projection.

7. The hinge mechanism according to claim 6, wherein said second projection is constituted by at least a portion of an annular circumferential collar.

8. The hinge mechanism according to claim 1, wherein said second portion comprises a third radially protruding projection, said cavity comprising a third recess that receives said third projection in said first rotational position of said second portion.

9. The hinge mechanism according to claim 3, wherein said sloped surface is a surface in said cavity and made of a resilient plastic material.

10. The mechanism according to claim 9, wherein said plastic material includes polyarylamide with glass fibers admixed therein.

11. The hinge mechanism according to claim 1, wherein a first stop surface is provided in said cavity for cooperation with a second stop surface of said second portion for determining said second rotational position.

12. The hinge mechanism according to claim 11, wherein the position of at least one of said first and second stop surfaces is adjustable for adjusting the location of said second rotational position.

13. The hinge mechanism according to claim 12, wherein said first stop surface comprises the end of rotatable element selected from the group consisting of a screw and a bolt.

14. The hinge mechanism according to claim 13, wherein said rotatable element extends from the outer surface of said body such that said rotatable element may be rotated from outside said body.

15. A hinge mechanism for folding a table leg toward a table top of a table, the mechanism comprising:
a pivot attachable to the table leg and pivotably attachable to the table top such that the pivot can rotate between a first position corresponding to the unfolded position of said leg and a second position corresponding to the folded position of said leg;
releasable locking means for releasably locking said pivot in said first position; and
frictional brake means for frictionally retaining said pivot in said second position.

16. A folding-leg table comprising a hinge mechanism for folding a table leg toward a table top of the table, the mechanism comprising:
a pivot attached to the table leg and pivotably attached to the table top such that the pivot can rotate between a first position corresponding to the unfolded position of said leg and a second position corresponding to the folded position of said leg;
releasable locking means for releasably locking said pivot in said first position; and
frictional brake means for frictionally retaining said pivot in said second position.

17. A folding-leg table comprising a hinge mechanism for folding a table leg towards a table top of the table, the mechanism comprising:
a body that is attached to the table top and having a cavity formed therein; and
a pivot having a first portion and a second portion, the first portion being connected to the table leg, the second portion being generally cylindrical and axially displaceable and rotatable between a first rotational position and a second rotational position in the cavity, said second portion comprising:
a radially protruding first projection; and
a biasing element adapted for applying a biasing force to urge said pivot in a first direction parallel to the axis of said second portion, said cavity comprising first and second recesses adapted for receiving said first projection when said second portion is displaced in said first direction in said first and second rotational positions, respectively,
the shape of said first projection being such relative to the shape of said first recess that rotation of said second portion is not allowed when said first projection is received in said first recess, and said shape of said first projection is such relative to the shape of said second recess that rotation of said second portion from said second position towards said first position causes said pivot to move in a second direction opposite said first direction against the biasing force of said biasing element, and
said second recess comprising a sloped surface arranged at an angle relative to said first direction, said first projection having a surface portion positioned to glide along said sloped surface when said second portion is displaced in said first direction in said second rotational position.

18. The table according to claim 17, wherein said sloped surface is a surface in said cavity and made of a resilient plastic material.

19. The table according to claim 18, wherein said plastic material includes polyarylamide with glass fibers admixed therein.

20. The table according to claim 17, wherein a first stop surface is provided in said cavity for cooperation with a second stop surface of said second portion for determining said second rotational position.

21. The table according to claim 20, wherein the position of at least one of said first and second stop surfaces is adjustable for adjusting the location of said second rotational position.

22. The table according to claim 21, wherein said first stop surface comprises the end of a rotatable element selected from the group consisting of a screw and a bolt.

23. The table according to claim 22, wherein said rotatable element extends from the outer surface of said body such that said rotatable element may be rotated from outside said body.
